(19) United States
(12) Patent Application Publication
(10) Pub. No.: US 2010/0250621 A1
(43) Pub. Date: Sep. 30, 2010

(54) FINANCIAL-ANALYSIS SUPPORT APPARATUS AND FINANCIAL-ANALYSIS SUPPORT METHOD

(75) Inventors: Kazunori KASHIMA, Kawasaki (JP); Eiji Arano, Kawasaki (JP); Shogo Yokosu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/649,966

(22) Filed: Dec. 30, 2009

(30) Foreign Application Priority Data
Mar. 31, 2009 (JP) 2009-087591

(51) Int. Cl. G06F 17/30

(52) U.S. Cl. 707/803; 707/E17.044

(57) ABSTRACT

A financial-analysis support apparatus compares XBRL data to be processed with a mapping creation taxonomy in which account items to be summarized are defined; if a new account item is added to the XBRL data, extracts a higher-level account item including the new account item as a low-level account item; if the extracted higher-level account item is included in the mapping creation taxonomy, adds the new account item under the higher-level account item defined in an aggregate-item definition that is what a structure of the XBRL data is stratified; creates a database definition based on a result of mapping obtained by adding the new account item to the aggregate-item definition thereby creating a summary database; and inputs data to the created summary database by using the XBRL data.

### CROSS-REFERENCE TO RELATED APPLICATION(S)

This application is based upon and claims the benefit of priority from Japanese Patent Application No. 20 09-087591, filed on Mar. 31, 2009, the entire contents of which are incorporated herein by reference.

### FIELD

The embodiments discussed herein are directed to a financial-analysis support apparatus and a financial-analysis support method.

### BACKGROUND

Conventionally, a company submits a financial report to the Financial Services Agency or the stock exchange (hereinafter, referred to as “the supervisory authority”) after the completion of settlement of accounts. The supervisory authority releases financial data reported from companies in HTML (HyperText Markup Language) or PDF (Portable Document Format) format or the like. A business analyzing companies, industry-wide trends, and the like (hereinafter, referred to as “the Business”) collects the financial data released by the supervisory authority and performs an analysis.

The Business manually inputs necessary financial data to comply with the Business's own financial analysis system based on the format, names of account items, etc. of each financial report that differs among companies. Therefore, it takes time for the Business to complete an analysis because an operator who inputs the financial data needs know-how and knowledge and may make an input error.

Consequently, nowadays, XBRL (extensible Business Reporting Language), an XML (Extensible Markup Language) based language, standardized so as to create, distribute, and use information for various financial reporting is being introduced. The Business puts information on a financial report expressed in the standardized XBRL, which is made by a company, in the Business's own XBRL-compliant financial analysis system. Various technologies for supporting such an analysis of financial data have been disclosed. Such technologies are disclosed in Japanese Laid-open Patent Publication No. 2007-164591 and Japanese Laid-open Patent Publication No. 2006-163876, for example.

However, in the conventional technologies described above, there is a issue of cost and man-hours involved in a financial analysis ranging from a data entry to an analysis. Specifically, since the Business has to change the Business's own existing system for financial analysis (for example, a relational database system, etc.) to an XBRL-compliant system (for example, an XBRL database system, etc.), it takes a considerable development cost.

Furthermore, when the Business uses the existing system for financial analysis, it causes a huge amount of mapping processes for establishing relationships between account items listed in a financial report (for example, a balance sheet, a statement of income, etc.) submitted to the supervisory authority by a company (including an account item uniquely-added by the company) and account items used for a financial analysis by the Business. With the huge amount of mapping processes, the Business makes a huge amount of redefinitions (for example, an addition of a new account item, etc.) to the Business's own database at the Business's own discretion, and thus it takes considerable man-hours.

### SUMMARY

According to an aspect of an embodiment of the invention, a financial-analysis support apparatus includes a new item addition determining unit that determines whether any new item is added to a structured document to be processed by comparing the structured document to be processed with a summary-target-item definition, which is a definition created in advance based on a predetermined structured document and in which items to be summarized are defined in advance; a higher-level item extracting unit that extracts, if it is determined that a new item is added, a higher-level item including the new item as a low-level item based on the structured document to be processed; a summary-target-item determining unit that determines whether the higher-level item extracted in the extracting is included in the summary-target-item definition; a new item definition adding unit that adds, if it is determined that the higher-level item of the new item is an object to be summarized, the new item under the higher-level item defined in an aggregate-item definition which is a definition created in advance based on the summary-target-item definition and is what the structured document is stratified; and a database creating unit that creates a database definition based on the aggregate-item definition to which the new item is added at the adding thereby creating a database, and inputting data to the database by using the structured document to be processed.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram for explaining an example of a configuration of a system including a financial-analysis support apparatus;

FIG. 2 is a diagram illustrating a configuration example of a financial-analysis support apparatus according to a first embodiment;

FIG. 3 is a diagram for explaining an example of XBRL data;

FIG. 4 is a diagram for explaining an example of a mapping creation taxonomy;

FIG. 5 is a diagram for explaining an example of an aggregate-item definition;

FIG. 6 is a diagram illustrating an example of a definition of a database created by a database creating unit;

FIG. 7 is a diagram illustrating an example of an aggregate-relationship definition of the database created by the database creating unit;

FIG. 8 is a diagram illustrating an example of a result of aggregation at the time of data input by the database creating unit;

FIG. 9 is a diagram for explaining an example of a parent-account-item identification logic;

FIG. 10 is a flowchart for explaining a flow of a financial-analysis support process according to the first embodiment;

FIG. 11 is a diagram for explaining an example of an aggregate relationship in different types of industry;

FIG. 12 is a diagram for explaining an example of variations in summary destination of account items; and

FIG. 13 is a diagram illustrating a computer that executes a financial-analysis support program.

### DESCRIPTION OF EMBODIMENTS

Preferred embodiments of the present invention will be explained with reference to accompanying drawings. The present invention is not limited to the embodiments below.

### [a] First Embodiment

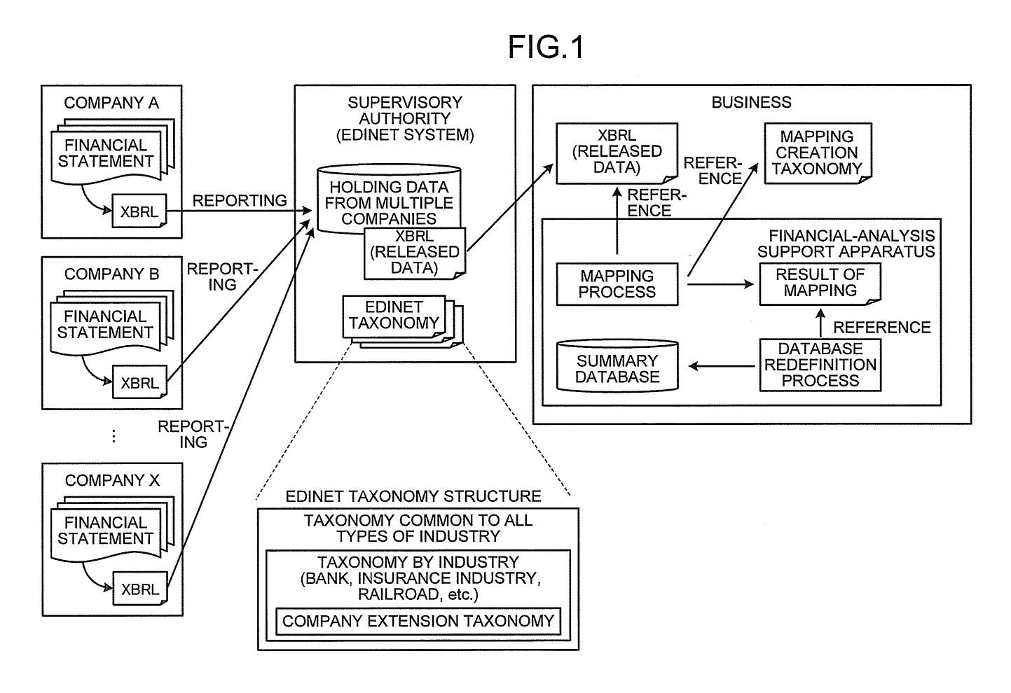

First, a configuration of a system including the financial-analysis support apparatus disclosed in the present application is explained with reference to FIG. 1. FIG. 1 is a diagram for explaining an example of the configuration of the system including the financial-analysis support apparatus.

The system including the financial-analysis support apparatus disclosed in the present application includes, for example, as illustrated in FIG. 1, at least one company, the supervisory authority, and the Business. Of them, the company (each of companies A to X) converts a financial statement and the like into XBRL data, and reports the XBRL data to the supervisory authority at every period. The supervisory authority holds the XBRL data reported by each company, and releases the held XBRL data. The Business analyzes data on finances using the XBRL data released by the supervisory authority.

In a taxonomy, which is an electronic form of financial reporting held in the supervisory authority, information on a name in Japanese, a name in English, the display order, a calculation relationship, a base article, a category of debit or credit, a category of duration or instant, etc. is set. There are taxonomies: a taxonomy common to all types of industry, a different taxonomy by each type of industry, a taxonomy uniquely-extended (added) by each company, etc.

In what follows, there is described a case where a current-period financial analysis is performed using XBRL data for the current and previous periods released by the supervisory authority. XBRL data used for a financial analysis is not limited to those for the current and previous periods.

In the configuration described above, the financial-analysis support apparatus compares a structured document to be processed with a summary-target-item definition, which is a definition created in advance based on a predetermined structured document and in which items to be summarized are defined in advance, and determines whether any new item is added to the structured document to be processed.

To explain specifically, the financial-analysis support apparatus compares XBRL data for the current period, which is an object to be processed, with a mapping creation taxonomy in which account items to be summarized are defined, and determines whether any new account item is added to the current-period XBRL data. The mapping creation taxonomy is a definition created in advance based on, for example, XBRL data for the previous period released by the supervisory authority.

Then, if determining that a new item is added, the financial-analysis support apparatus extracts a higher-level item including the new item as a low-level item based on the structured document to be processed.

To explain specifically with the case described above, if determining that a new account item “Other” is added to the XBRL data for the current period, the financial-analysis support apparatus extracts a higher-level account item “Property, plant, and equipment” including the added new account item “Other” as a low-level account item in reference to the XBRL data to be processed.

Subsequently, the financial-analysis support apparatus determines whether the extracted higher-level item is included in the summary-target-item definition. After that, if determining that the higher-level item of the new item is an object to be summarized, the financial-analysis support apparatus adds the new item under the higher-level item defined in an aggregate-item definition, which is a definition created in advance based on the summary-target-item definition and is what the structured document is stratified.

To explain specifically with the case described above, the financial-analysis support apparatus determines whether the extracted higher-level account item “Property, plant, and equipment” is included in the mapping creation taxonomy. Here, it is assumed that the higher-level account item “Property, plant, and equipment” is included in the mapping creation taxonomy, and the higher-level account item “Property, plant, and equipment” is an object to be summarized.

Then, if determining that the higher-level account item “Property, plant, and equipment” is an object to be summarized, the financial-analysis support apparatus adds the new account item “Other” under the higher-level account item “Property, plant, and equipment” defined in the aggregate-item definition. The aggregate-item definition is a definition created in advance based on, for example, the mapping creation taxonomy, and a definition that a structure of a parent-child relationship between a higher-level account item and a low-level account item in XBRL data, etc. is stratified.

To cite an example of the aggregate-item definition specifically, in a case of XBRL data including “Property, plant, and equipment” as the first subitem of those under “Fixed assets” and “Machinery and equipment” as the second subitem of those under “Property, plant, and equipment”, “Fixed assets” is defined as “1”, “Property, plant, and equipment” is defined as “1 1”, and “Machinery and equipment” is defined as “1 1 2”. If “Other” is located on the sixth of those under “Property, plant, and equipment”, the financial-analysis support apparatus adds the new account item “Other” as “1 1 6”. In other words, the financial-analysis support apparatus outputs a result of mapping that the new account item “Other: 1 1 6” is added to the aggregate-item definition.

Then, the financial-analysis support apparatus creates a database definition based on the aggregate-item definition to which the new item is added thereby creating a database, and inputs data to the database by using the structured document to be processed.

To explain specifically with the case described above, the financial-analysis support apparatus creates a database definition in reference to the result of mapping thereby creating a summary database. Then, the financial-analysis support apparatus inputs data to the created summary database by using the XBRL data for the current period.

In this manner, since the financial-analysis support apparatus reflects a newly-added account item in XBRL data released by the supervisory authority in the database without changing the Business's own existing database for financial analysis to the XBRL format, it is possible to streamline operations involved in a financial analysis ranging from a data entry to an analysis.

Configuration of Financial-Analysis Support Apparatus

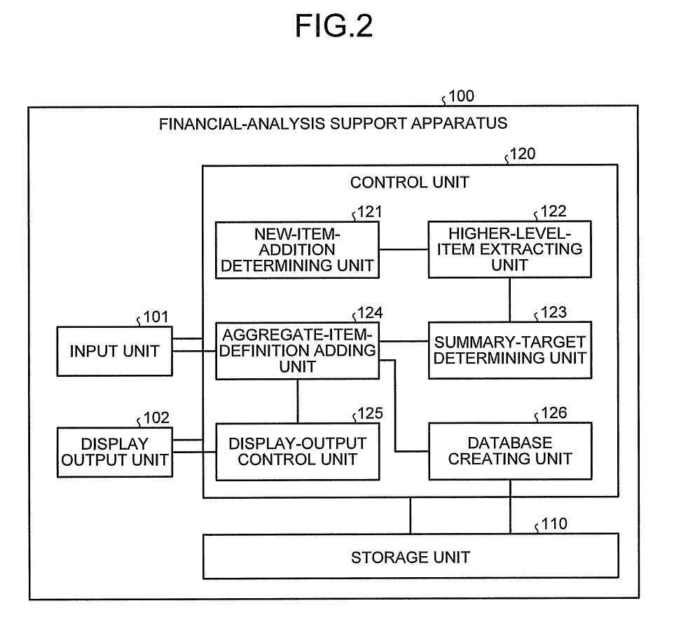

Subsequently, a configuration of the financial-analysis support apparatus according to the first embodiment is explained with reference to FIG. 2. FIG. 2 is a diagram illustrating a configuration example of the financial-analysis support apparatus according to the first embodiment.

As illustrated in FIG. 2, a financial-analysis support apparatus 100 includes an input unit 101, a display output unit 102, a storage unit 110, and a control unit 120.

The input unit 101 includes, for example, a keyboard, a mouse, etc., and receives the input of various information in the financial-analysis support apparatus 100. The display output unit 102 includes, for example, a monitor (or a display, a touch-sensitive panel, etc.) and a speaker, and outputs various information in the financial-analysis support apparatus 100.

Specifically, the display output unit 102 outputs various information controlled to be displayed by a display-output control unit 125 to be described later. For example, when a new account item is added, or when a higher-level account item of the new account item is not included in objects to be summarized, the display output unit 102 displays thereon the new account item and/or the higher-level account item.

The storage unit 110 stores therein data required for various processes performed by the control unit 120 and results of the processes performed by the control unit 120.

The control unit 120 includes an internal memory for storing a control program, programs for defining respective procedures of the processes, and the required data, and specifically includes a new-item-addition determining unit 121, a higher-level-item extracting unit 122, a summary-target determining unit 123, an aggregate-item-definition adding unit 124, the display-output control unit 125, and a database creating unit 126, and executes various processes with these units.

The new-item-addition determining unit 121 compares a structured document to be processed with the summary-target-item definition, which is a definition created in advance based on a predetermined structured document and in which items to be summarized are defined in advance, and determines whether any new item is added to the structured document to be processed.

To take an example specifically, the new-item-addition determining unit 121 compares XBRL data for the current period, which is an object to be processed, with the mapping creation taxonomy in which account items to be summarized are defined, and determines whether any new account item is added to the XBRL data for the current period.

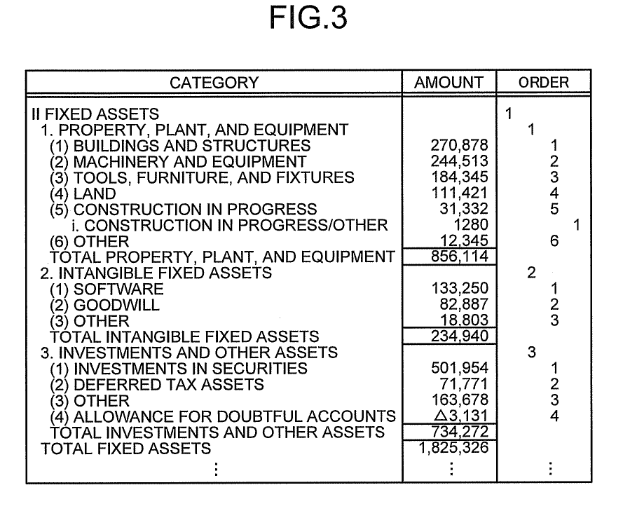

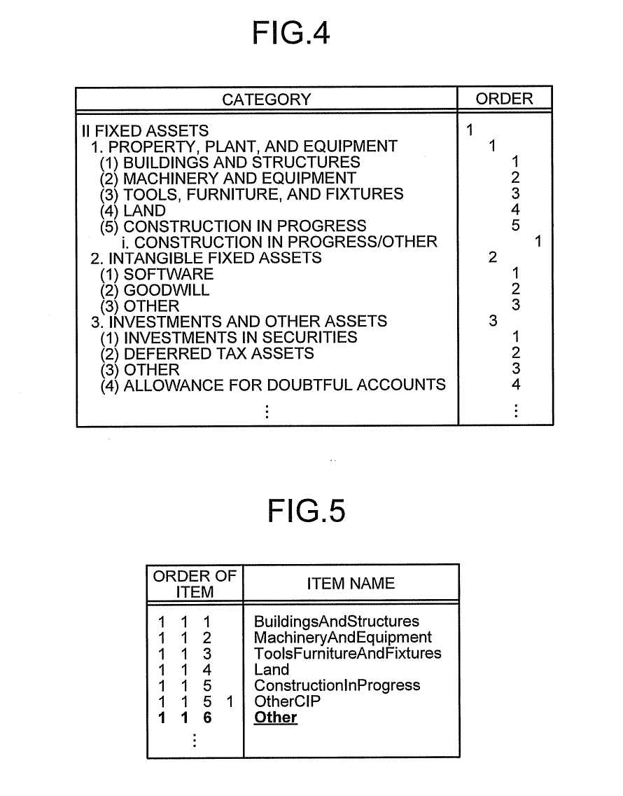

Here, XBRL data released by the supervisory authority is explained with reference to FIG. 3. FIG. 3 is a diagram for explaining an example of the XBRL data. Furthermore, the mapping creation taxonomy in which account items to be summarized are defined is explained with reference to FIG. 4. FIG. 4 is a diagram for explaining an example of the mapping creation taxonomy.

For example, as illustrated in FIG. 3, the XBRL data includes “Category” indicating a category to which each account item belongs, “Amount” indicating an amount with respect to each account item, and “Order” indicating the order of item in the stratified structure of account items. Of them, “Category” contains, for example, under “II Fixed assets”, “1. Property, plant, and equipment” as the first subitem, “2. Intangible fixed assets” as the second subitem, and “3. Investments and other assets” as the third subitem.

Furthermore, “1. Property, plant, and equipment” contains “(1) Buildings and structures” as the first subitem, “(2) Machinery and equipment” as the second subitem, “(3) Tools, furniture, and fixtures” as the third subitem, “(4) Land” as the fourth subitem, “(5) Construction in progress” as the fifth subitem, and “(6) Other” as the sixth subitem. Moreover, “(5) Construction in progress”, the fifth subitem of “1. Property, plant, and equipment”, contains “i. Construction in progress/Other” as the first subitem.

On the other hand, “2. Intangible fixed assets” contains “(1) Software” as the first subitem, “(2) Goodwill” as the second subitem, and “(3) Other” as the third subitem. Furthermore, “3. Investments and other assets” contains “(1) Investments in securities” as the first subitem, “(2) Deferred tax assets” as the second subitem, “(3) Other” as the third subitem, and “(4) Allowance for doubtful accounts” as the fourth subitem.

Moreover, “Amount” indicates a value (an instance) of an amount of money corresponding to each account item, for example, contained under each of “1. Property, plant, and equipment”, “2. Intangible fixed assets”, and “3. Investments and other assets”. Then, “Amount” contains respective total amounts of “1. Property, plant, and equipment”, “2. Intangible fixed assets”, and “3. Investments and other assets” and a total amount of “II Fixed assets”.

Furthermore, “Order” with respect to each account item is, for example, if “II Fixed assets” is “1”, that “1. Property, plant, and equipment” is “1 1”, “(1) Buildings and structures” is “1 1 1”, “(2) Machinery and equipment” is “1 1 2”, “(3) Tools, furniture, and fixtures” is “1 1 3”, “(4) Land” is “1 1 4”, “(5) Construction in progress” is “1 1 5”, “i. Construction in progress/Other” is “1 1 5 1”, and “(6) Other” is “1 1 6”.

Moreover, for example, as illustrated in FIG. 4, the mapping creation taxonomy includes “Category” indicating a category to which each account item belongs and “Order” indicating the order of item in the stratified structure of account items. In the mapping creation taxonomy, as described above, account items to be summarized are defined, i.e., account items to be summarized for a financial analysis are defined by the Business based on XBRL data.

Specifically, the mapping creation taxonomy is predefined by the Business based on arbitrary XBRL data released at every period, and all account items including low-level account items do not need to be defined in the mapping creation taxonomy. In other words, when all account items located under a predetermined higher-level account item are objects to be summarized, it is only necessary to define at least the higher-level account item in the mapping creation taxonomy.

The XBRL data used to define the mapping creation taxonomy is not limited to XBRL data for the previous period, and can be arbitrary XBRL data or a combination of some XBRL data. Furthermore, each definition included in the mapping creation taxonomy is identical to the corresponding item having the same name illustrated in FIG. 3, so the description of each definition is omitted.

Below, it is assumed that “(6) Other”, the sixth subitem of “1. Property, plant, and equipment”, is added to the XBRL data for the current period in comparison with the mapping creation taxonomy.

When the new-item-addition determining unit 121 determines that a new item is added to the XBRL data for the current period, the higher-level-item extracting unit 122 extracts a higher-level item containing the new item as a low-level item based on the structured document to be processed.

To cite the case described above specifically, when the new-item-addition determining unit 121 determines that the new account item “(6) Other” is added, the higher-level-item extracting unit 122 extracts the higher-level account item “1. Property, plant, and equipment” containing the added new account item “(6) Other” as a low-level account item in reference to the XBRL data for the current period, which is an object to be processed.

The summary-target determining unit 123 determines whether the higher-level item extracted by the higher-level-item extracting unit 122 is included in the summary-target-item definition.

To cite the case described above specifically, the summary-target determining unit 123 determines whether the higher-level account item “1. Property, plant, and equipment” extracted by the higher-level-item extracting unit 122 is included in the mapping creation taxonomy. Below, it is assumed that the higher-level account item “1. Property, plant, and equipment” is included in the mapping creation taxonomy.

When the summary-target determining unit 123 determines that the extracted higher-level item is an object to be summarized, the aggregate-item-definition adding unit 124 adds the new item under the higher-level item defined in the aggregate-item definition, which is a definition created in advance based on the summary-target-item definition and is what the structured document is stratified.

To cite the case described above specifically, when the summary-target determining unit 123 determines that the higher-level account item “1. Property, plant, and equipment” (“Order of item: 1”) is an object to be summarized, the aggregate-item-definition adding unit 124 adds the new account item “(6) Other” (Order of item: 1 1 6) under “1. Property, plant, and equipment” defined in the aggregate-item definition.

Here, the aggregate-item definition is explained with reference to FIG. 5. FIG. 5 is a diagram for explaining an example of the aggregate-item definition.

For example, as illustrated in FIG. 5, the aggregate-item definition includes “Order of item (Order)” and “Item name” in an associated manner, and “Order of item” denotes numerical values indicating the order of item in the stratified structure of the XBRL data, and “Item name” indicates a name of a corresponding account item. In other words, the aggregate-item definition is a definition created in advance based on the mapping creation taxonomy, and is a definition in which a stratified structure of a parent-child relationship between a higher-level account item and a low-level account item in the XBRL data, etc. is expressed by numerical values.

Of them, the order of item “1 1 1” is associated with an item name “BuildingsAndStructures”, the order of item “1 1 2” is associated with an item name “MachineryAndEquipment”, and the order of item “1 1 3” is associated with an item name “ToolsFurnitureAndFixtures”.

Furthermore, the order of item “1 1 4” is associated with an item name “Land”, the order of item “1 1 5” is associated with an item name “ConstructionInProgress”, and the order of item “1 1 5 1” is associated with an item name “OtherCIP”.

If the new account item “(6) Other” is an object to be summarized, the aggregate-item-definition adding unit 124 adds the order of item “1 1 6” and an item name “Other” to the aggregate-item definition in an associated manner. Below, the aggregate-item definition to which a new account item to be summarized is added is referred to as a result of mapping.

When the summary-target determining unit 123 determines that the higher-level item of the new item is not an object to be summarized, the display-output control unit 125 causes the display output unit 102 to display the new item and/or the higher-level item.

For example, when the higher-level account item “1. Property, plant, and equipment” of the new account item “(6) Other” is not included in the mapping creation taxonomy, i.e., when the higher-level account item is erroneously not summarized in the mapping creation taxonomy, or when account items in all strata, including higher-level account items, are newly added to the XBRL data for the current period, the display-output control unit 125 causes the display output unit 102 to display the new account items and/or the higher-level items.

In response, the Business determines whether to involve the account item displayed on the display output unit 102 as an object to be summarized, and inputs the account item through the input unit 101 if determining to involve the account item as an object to be summarized. Then, the aggregate-item-definition adding unit 124 outputs a result of mapping that the account item input through the input unit 101 is added to the aggregate-item definition.

Furthermore, the display-output control unit 125 causes the display output unit 102 to display the aggregate-item definition to which the new item is added by the aggregate-item-definition adding unit 124.

For example, the display-output control unit 125 causes the display output unit 102 to display a result of mapping that the new account item “(6) Other” is added to the aggregate-item definition by the aggregate-item-definition adding unit 124. In response, the Business confirms the result of mapping displayed on the display output unit 102, and for example, if the Business wants to delete any account item from those displayed on the display output unit 102, inputs the account item through the input unit 101. Then, the aggregate-item-definition adding unit 124 deletes the account item input through the input unit 101 from the result of mapping. The above-described process performed by the display-output control unit 125 can be omitted.

The database creating unit 126 creates a database definition based on the aggregate-item definition to which the new item is added by the aggregate-item-definition adding unit 124 thereby creating a database, and inputs data to the database by using the structured document to be processed.

To take an example specifically with the case described above, the database creating unit 126 creates a database definition based on the result of mapping output by the aggregate-item-definition adding unit 124.

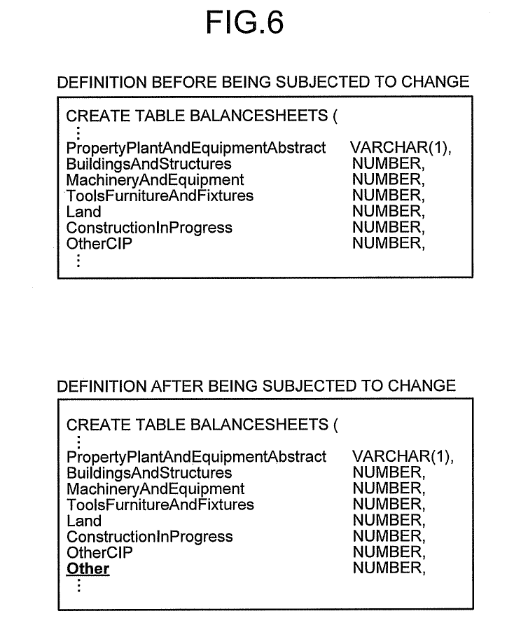

A table definition of the database to be created is, for example, as illustrated in FIG. 6, a definition after being subjected to change that “Other” is added to a definition before being subjected to change. FIG. 6 is a diagram illustrating an example of the database definition created by the database creating unit 126.

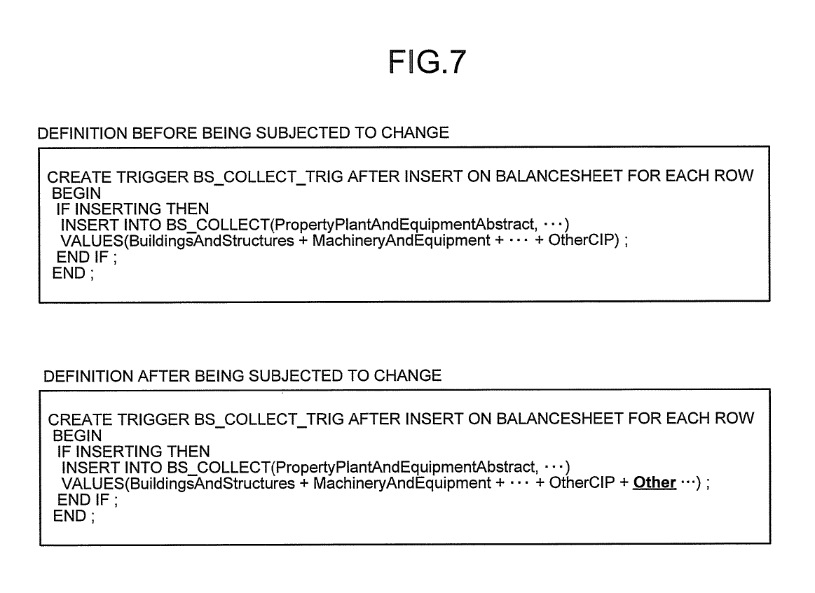

Furthermore, an aggregate-relationship definition of the database to be created is, for example, as illustrated in FIG. 7, a definition after being subjected to change that “Other” is added to a definition before being subjected to change with the creation of the table definition. FIG. 7 is a diagram illustrating an example of the aggregate-relationship definition of the database created by the database creating unit 126.

Then, the database creating unit 126 creates a summary database in accordance with the created database definition and an aggregate relationship. Subsequently, the database creating unit 126 inputs data to the created summary database by using the XBRL data for the current period, which is an object to be processed. The summary database can be included in the storage unit 110 or an external storage device connected to the financial-analysis support apparatus 100.

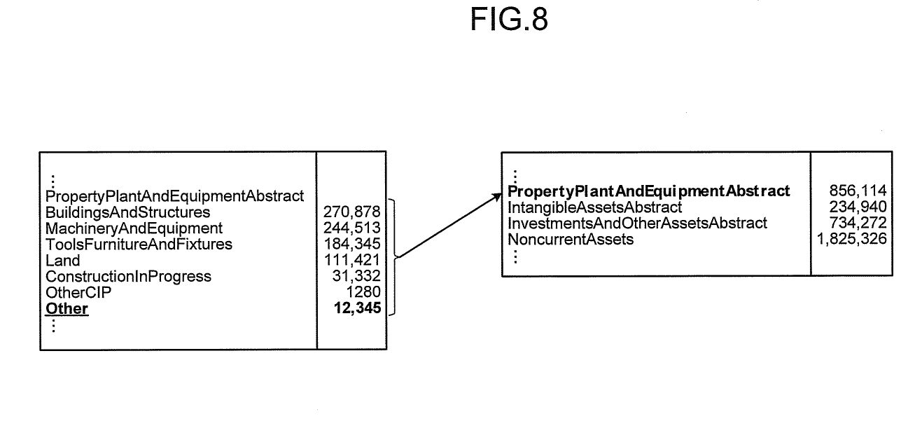

As for a result of aggregation at the time of data input by the database creating unit 126, for example, by referring to a trigger describing an aggregate relationship (see FIG. 7) when data is added to an aggregate-relationship definition table, as illustrated in FIG. 8, a result of aggregation is added to the aggregate-item definition. In short, as illustrated in FIG. 8, a result of aggregation is a data value “856114” in which “12345”, a data value of “Other”, is also summarized. FIG. 8 is a diagram illustrating an example of a result of aggregation at the time of data input by the database creating unit 126.

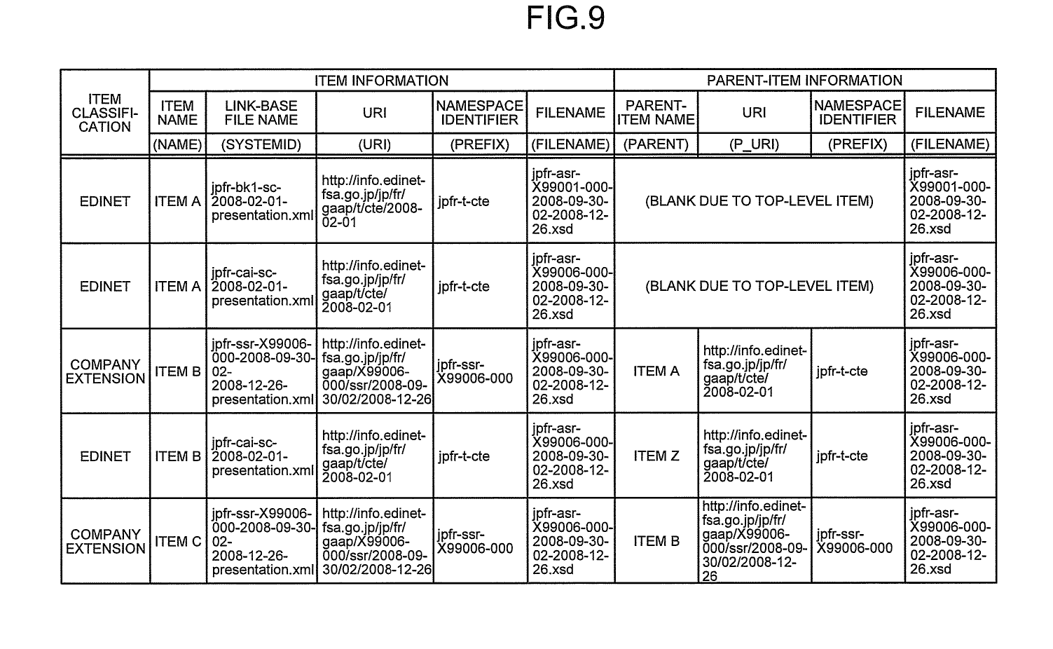

Here, a parent-account-item identification logic performed by the higher-level-item extracting unit 122 is explained in detail with reference to FIG. 9. FIG. 9 is a diagram for explaining an example of the parent-account-item identification logic.

As illustrated in FIG. 9, “Item classification” for classifying each account item includes “EDINET”, which is a taxonomy common to all types of industry or the same type of industry, and “COMPANY EXTENSION”, which is added (extended) by each company. Each item in each item classification includes “Item name (NAME)” indicating a name of an account item and “Link-base file name (SYSTEMID)” defining the display order of the account item among account items, “URI (Uniform Resource Identifier)” and “Namespace identifier (PREFIX)” indicating location information of the account item, and “FILENAME” indicating a name of a file in an associated manner.

Furthermore, each account item holds information on a parent account item of the account item, and the information on the parent account item similarly includes “Parent-item name (PARENT)”, “URI (P_URI)”, “Namespace identifier (PREFIX)”, and “FILENAME”. In the structure described above, there is described below a case where a higher-level item of “ITEM C” which item classification is “COMPANY EXTENSION” is extracted.

For example, the financial-analysis support apparatus 100 extracts a higher-level item with, as a retrieval key, “Parent-item name: ITEM B”, information on a parent item containing a low-level item corresponding to “Item name: ITEM C” which item classification is “COMPANY EXTENSION”. Then, the financial-analysis support apparatus 100 extracts “Item name: ITEM B” which item classification is “COMPANY EXTENSION” and “Item name: ITEM B” which item classification is “EDINET”.

Here, since there are a plurality of parent account items extracted, the financial-analysis support apparatus 100 again extracts an item with “Parent-item name: ITEM B” and “Namespace identifier: jpfr-ssr-X99006-000” as retrieval keys. Then, as a result of the retrieval of item with the above two as retrieval keys, the financial-analysis support apparatus 100 extracts “Item name: ITEM B” which item classification is “COMPANY EXTENSION”.

Subsequently, the financial-analysis support apparatus 100 extracts an item with, as a retrieval key, “Parent-item name: ITEM A”, information on a parent item containing a low-level item corresponding to “Item name: ITEM B” which item classification is “COMPANY EXTENSION”. After that, the financial-analysis support apparatus 100 extracts “Item name: ITEM A” which item classification is “EDINET” and “Item name: ITEM A” which item classification is “EDINET”.

Here, since there are a plurality of parent account items extracted, the financial-analysis support apparatus 100 again extracts an item with “Parent-item name: ITEM A” and “Namespace identifier: jpfr-t-cte” as retrieval keys. Then, as a result of the retrieval of item with the above two as retrieval keys, the financial-analysis support apparatus 100 extracts “Item name: ITEM A” which item classification is “EDINET” and “Item name: ITEM A” which item classification is “EDINET”.

Once again, there are a plurality of parent account items extracted, so the financial-analysis support apparatus 100 again extracts an item with “Parent-item name: ITEM A”, “Namespace identifier: jpfr-t-cte”, and “URI: http://info.edinet-fsa.go.jp/jp/fr/gaap/t/cte/2008-02-01” as retrieval keys. Then, as a result of the retrieval of item with the above three as retrieval keys, the financial-analysis support apparatus 100 extracts “Item name: ITEM A” which item classification is “EDINET” and “Item name: ITEM A” which item classification is “EDINET”.

Further once again, there are a plurality of parent account items extracted, so the financial-analysis support apparatus 100 again extracts an item with “Parent-item name: ITEM A”, “Namespace identifier: jpfr-t-cte”, “URI: http://info.edinet-fsa.go.jp/jp/fr/gaap/t/cte/2008-02-01”, and “FILENAME: jpfr-asr-X99006-000-2008-09-30-02-2008-12-26.xsd” as retrieval keys. Then, as a result of the retrieval of item with the above four as retrieval keys, the financial-analysis support apparatus 100 extracts “Item name: ITEM A” which item classification is “EDINET” and containing “X99006” in “FILENAME”.

In this manner, with, as a retrieval key, at least one piece of information out of pieces of information on a higher-level item included in information that a new item has, the financial-analysis support apparatus 100 extracts a higher-level item including the new item as a low-level item. In other word, the financial-analysis support apparatus 100 performs an extraction of a parent account item including a new account item added, i.e., extended by a company or the like as a low-level item by retrieving the parent account item with a plurality of pieces of information included in information that the new account item has, and thus even if there are a plurality of candidate parent account items, the financial-analysis support apparatus 100 can identify one parent account item.

Flow of Financial-Analysis Support Process

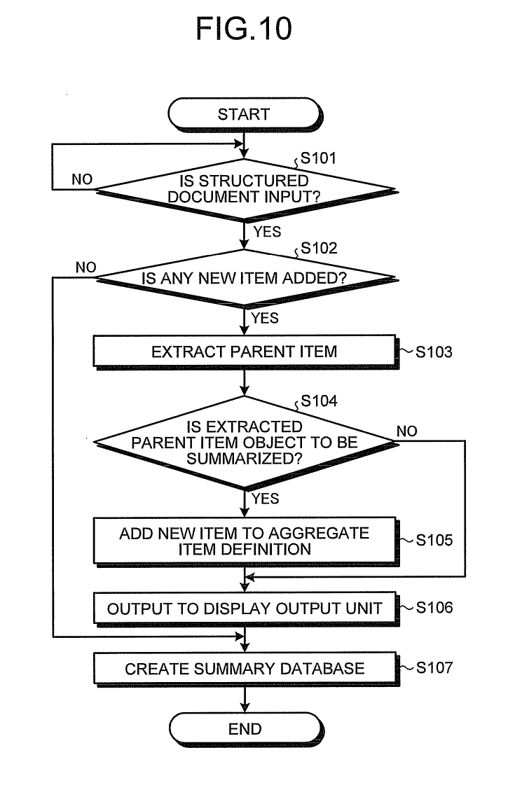

Subsequently, a flow of a financial-analysis support process according to the first embodiment is explained with reference to FIG. 10. FIG. 10 is a flowchart for explaining the flow of the financial-analysis support process according to the first embodiment.

For example, as illustrated in FIG. 10, if XBRL data that is released by the supervisory authority and is the one for the current period, an object to be processed for a financial analysis, is input (YES at Step S101), the financial-analysis support apparatus 100 receives the input XBRL data.

Then, the financial-analysis support apparatus 100 compares the received XBRL data for the current period with the mapping creation taxonomy in which account items to be summarized are defined, and determines whether any new account item is added to the XBRL data for current period (Step S102). Subsequently, if determining that an account item “(6) Other” is added as a new account item (YES at Step S102), the financial-analysis support apparatus 100 extracts a higher-level account item “1. Property, plant, and equipment” including the added new account item “(6) Other” as a low-level account item in reference to the XBRL data for the current period which is an object to be processed (Step S103).

After that, the financial-analysis support apparatus 100 determines whether the extracted higher-level account item “1. Property, plant, and equipment” is included in the mapping creation taxonomy (Step S104). Then, if determining that the extracted higher-level account item “1. Property, plant, and equipment” is an object to be summarized (YES at Step S104), the financial-analysis support apparatus 100 adds the new account item “(6) Other” (Order of item: 1 1 6) under the higher-level account item “1. Property, plant, and equipment” (“Order of item: 1”) defined in the aggregate-item definition, and outputs a result of mapping (Step S105).

Subsequently, the financial-analysis support apparatus 100 causes the display output unit 102 to display the result of mapping obtained by the addition of the new account item to the aggregate-item definition (Step S106). After that, the financial-analysis support apparatus 100 creates a database definition based on the result of mapping thereby creating a summary database, and inputs data to the created summary database by using the XBRL data for the current period (Step S107).

If determining that no new account item is added to the XBRL data for current period (NO at Step S102), the financial-analysis support apparatus 100 creates a database definition in accordance with the previous aggregate-item definition, and executes a process at Step S107.

If determining that the extracted higher-level account item is not included in the mapping creation taxonomy (NO at Step S104), at Step S104, the financial-analysis support apparatus 100 causes the display output unit 102 to display the added new account item and/or the corresponding higher-level account item. At this time, the Business determines whether to add the account item displayed on the display output unit 102 to the aggregate-item definition. Then, the financial-analysis support apparatus 100 creates a database definition in accordance with a result of mapping obtained by an addition of the account item made by the Business or the previous aggregate-item definition.

### Advantage of First Embodiment

As described above, the financial-analysis support apparatus 100 compares XBRL data to be processed with the mapping creation taxonomy in which account items to be summarized are defined; if an account item is newly added to the XBRL data, extracts a higher-level account item including the new account item as a low-level account item; if the extracted higher-level account item is an object to be summarized in reference to the mapping creation taxonomy, adds the new account item under the higher-level account item in the aggregate-item definition and outputs a result of mapping; creates a database definition in accordance with the result of mapping thereby creating a summary database; and inputs data to the created summary database by using the XBRL data to be processed, and thus it is possible to streamline operations involved in a financial analysis ranging from a data entry to an analysis.

Furthermore, even when there are a plurality of account items to be processed in summary account items, the financial-analysis support apparatus 100 can store the account items in corresponding positions in the summary account items without human intervention in a determination of a summary location, an extension of the database, etc.

Moreover, even when a new account item that has not been used previously is an object to be summarized, the financial-analysis support apparatus 100 can store the new account item as a new account item of the summary account items without human intervention in an extension of the database, etc.

Furthermore, the financial-analysis support apparatus 100 displays account items including a new account item that has not been used previously on a predetermined display output unit as a list of candidate account items to be summarized, and thus it is possible to prevent a mistake in summary of account items including the one not to be summarized, and also possible to support the financial analysis.

### [b] Second Embodiment

The embodiment of the present invention is described above, but the present invention can be embodied in various different forms other than that is described in the embodiment above. So, there is described an embodiment different in (1) an aggregate relationship in different types of industry, (2) a configuration of the financial-analysis support apparatus, and (3) a program.

(1) Aggregate Relationship in Different Types of Industry

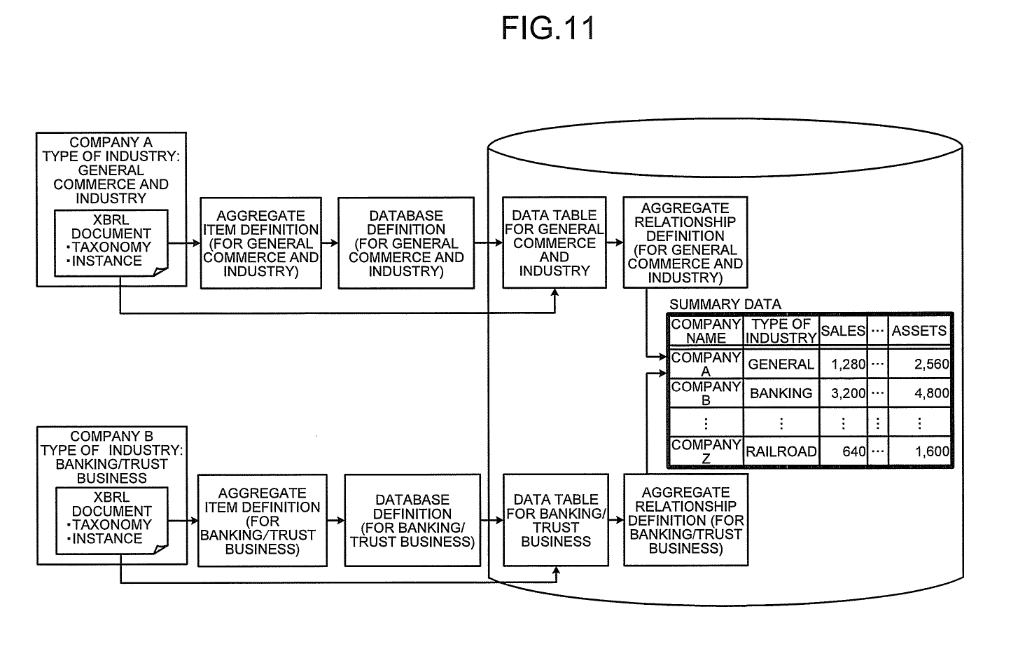

In the first embodiment described above, there is described the creation of summary data in a financial analysis with respect to a certain company; however, the present invention is not limited to this, and summary data in different types of industry can be created based on summary data created by each company. An aggregate relationship in different types of industry is explained below with reference to FIG. 11. FIG. 11 is a diagram for explaining an example of the aggregate relationship in the different types of industry.

For example, as illustrated in FIG. 11, the financial-analysis support apparatus 100 creates aggregate-relationship definitions as described in the first embodiment on companies which types of industry are “general commerce and industry (general company)” and “banking/trust business”, respectively. Then, the financial-analysis support apparatus 100 edits a value of each account item in accordance with the created aggregate-relationship definitions, and creates a summary database.

Since even the same account item in a general company, a bank-affiliated company may vary in aggregate items of asset account. Accordingly, although the conventional manner is that the user summarizes data based on visual judgment, the financial-analysis support apparatus 100 can achieve a summary of account items having different meanings among groups of companies by setting aggregate items with respect to each group of companies and associating the aggregate items with each company's taxonomy.

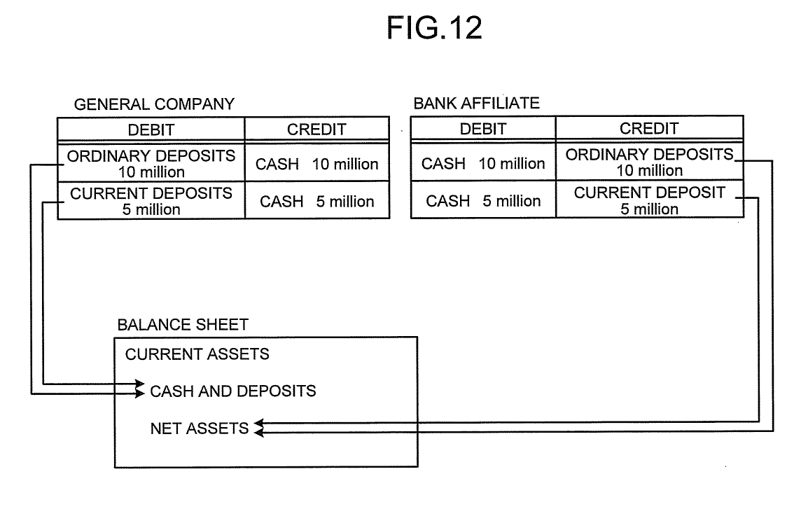

Furthermore, for example, as illustrated in FIG. 12, in a general company and a bank-affiliated company, debits of the general company are “Debit: Ordinary deposit (10 million)” and “Debit: Current deposit (5 million)”, and credits of the bank-affiliated company are “Credit: Ordinary deposit (10 million)” and “Credit: Current deposit (5 million)”. That is, in this case illustrated in FIG. 12, a summary destination of account items varies between the general company and the bank-affiliated company. Because of this, a user's visual judgment or know-how has been required of a user conventionally.

On the other hand, as for the financial-analysis support apparatus 100, in a case where even the same summary item (account item) differs in data summary location depending on the operation, the financial-analysis support apparatus 100 can streamline operations involved in a financial analysis ranging from a data entry to an analysis without causing a user to check whether a company is a general company or a bank-affiliated company or without developing a program to determine a summary destination. FIG. 12 is a diagram for explaining an example of the variations in summary destination of account items.

(2) Configuration of Financial-Analysis Support Apparatus

The processing procedure, control procedure, specific names, and information including various data or parameters (for example, a specific name, such as the aggregate-item definition, etc.) illustrated in the above and drawings can be arbitrarily changed unless otherwise specified.

Furthermore, constituent elements of each unit illustrated in the drawings are just functionally and conceptually depicted, and do not always have to be physically configured as illustrated in the drawings. That is, a specific configuration of distribution/integration of units is not limited to those illustrated in the drawings, and all or part of the units can be distributed or integrated functionally or physically in an arbitrary unit depending on various loads or usage statuses, for example, “the new-item-addition determining unit 121” and “the higher-level-item extracting unit 122” can be integrated as “an additional-higher-level-item extracting unit” for extracting, when a new account item is added, a higher-level account item of the new account item. Moreover, all or any part of processing functions performed by the units can be realized by a CPU and programs, which are each analyzed and executed by the CPU, or can be realized as hardware based on a wired logic.

(3) Program

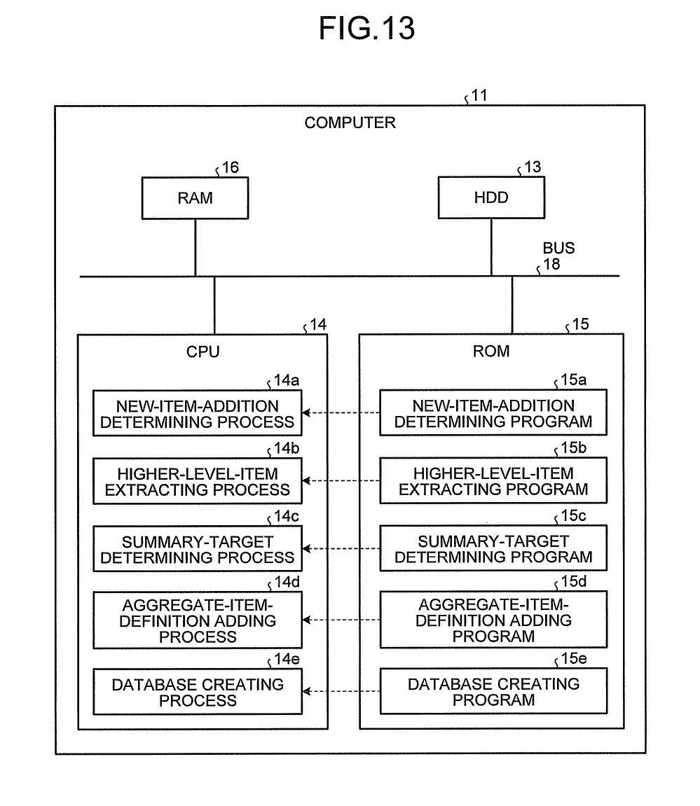

In the first embodiment described above, there is described a case where each process is realized by a hardware logic; however, the present invention is not limited to this, and each process can be realized by causing a computer to execute a program prepared in advance. So, there is described an example of a computer that executes a financial-analysis support program having the same functions as the financial-analysis support apparatus 100 illustrated in the embodiment described above with reference to FIG. 13. FIG. 13 is a diagram illustrating the computer that executes the financial-analysis support program.

As illustrated in FIG. 13, a computer 11, as the financial-analysis support apparatus, includes an HDD 13, a CPU 14, a ROM 15, and a RAM 16 that are connected to one another by a bus 18.

In the ROM 15, a financial-analysis support program fulfilling the same functions as the financial-analysis support apparatus 100 illustrated in the first embodiment, i.e., as illustrated in FIG. 11, a new-item-addition determining program 15a, a higher-level-item extracting program 15b, a summary-target determining program 15c, an aggregate-item-definition adding program 15d, and a database creating program 15e are stored in advance. These programs 15a to 15e can be arbitrarily integrated or distributed in the same manner as constituent elements of the financial-analysis support apparatus 100 illustrated in FIG. 2.

The CPU 14 reads out these programs 15a to 15e from the ROM 15 and executes the programs 15a to 15e, and the programs 15a to 15e, respectively, function as a new-item-addition determining process 14a, a higher-level-item extracting process 14b, a summary-target determining process 14c, an aggregate-item-definition adding process 14d, and a database creating process 14e as illustrated in FIG. 13. These processes 14a to 14e, respectively, correspond to the new-item-addition determining unit 121, the higher-level-item extracting unit 122, the summary-target determining unit 123, the aggregate-item-definition adding unit 124, and the database creating unit 126 illustrated in FIG. 2.

The CPU 14 executes the financial-analysis support program based on data recorded on the RAM 16.

The above-described programs 15a to 15e do not always have to be stored in the ROM 15 in advance, and can be stored in, for example, “a portable physical medium” inserted into the computer 11, such as a flexible disk (FD), a CD-ROM, a DVD disk, a magnet-optical disk, and an IC card, or “a fixed physical medium” provided inside or outside the computer 11, such as an HDD, “another computer (or a server)” connected to the computer 11 via a public line, the Internet, a LAN, a WAN, or the like, etc, so that the computer 11 can read out the programs from these and execute the programs.

According to an embodiment, it is possible to streamline operations involved in a financial analysis ranging from a data entry to an analysis.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable storage medium having stored therein a financial-analysis support program, the financial-analysis support program causing a computer to execute a process comprising:
determining whether any new item is added to a structured document to be processed by comparing the structured document to be processed with a summary-target-item definition, which is a definition created in advance based on a predetermined structured document and in which items to be summarized are defined in advance;
extracting, if it is determined that a new item is added, a higher-level item including the new item as a low-level item based on the structured document to be processed;
determining whether the higher-level item extracted in the extracting is included in the summary-target-item definition;
adding, if it is determined that the higher-level item of the new item is an object to be summarized, the new item under the higher-level item defined in an aggregate-item definition which is a definition created in advance based on the summary-target-item definition and is what the structured document is stratified; and
creating a database definition based on the aggregate-item definition to which the new item is added at the adding thereby creating a database, and inputting data to the database by using the structured document to be processed.

2. The computer readable storage medium according to claim 1, wherein the extracting includes extracting a higher-level item including the new item as a low-level item with, as a retrieval key, at least one piece of information out of pieces of information on the higher-level item included in information that the new item has.

3. The computer readable storage medium according to claim 1, the process further comprising displaying the new item and/or the higher-level item on a display output unit if it is determined in the second determining that the higher-level item of the new item is not an object to be summarized.

4. The computer readable storage medium according to claim 3, wherein the displaying further includes displaying the aggregate-item definition to which the new item is added in the adding on the display output unit.

5. The computer readable storage medium according to claim 1, wherein
each item includes, as information on the item itself, an item name, a link-base file name for defining the display order of the item among items, and a URI and a namespace identifier indicating location information of the item, and further includes, as information on a higher-level item including the item as a low-level item, a parent item name, a URI and a namespace identifier indicating location information of the higher-level item, and FILENAME indicating a name of a file, and
the extracting includes extracting one of higher-level items including the new item as a low-level item by retrieving an item name, a link-base file name, a URI, a namespace identifier, and FILENAME that are included in the higher-level item with, as a retrieval key, at least one piece of information out of a parent item name, a URI, a namespace identifier, and FILENAME that are information on the higher-level item included in information that the new item has.

6. A financial-analysis support apparatus, comprising:
a new item addition determining unit that determines whether any new item is added to a structured document to be processed by comparing the structured document to be processed with a summary-target-item definition, which is a definition created in advance based on a predetermined structured document and in which items to be summarized are defined in advance;
a higher-level item extracting unit that extracts, if it is determined that a new item is added, a higher-level item including the new item as a low-level item based on the structured document to be processed;
a summary-target-item determining unit that determines whether the higher-level item extracted in the extracting is included in the summary-target-item definition;
a new item definition adding unit that adds, if it is determined that the higher-level item of the new item is an object to be summarized, the new item under the higher-level item defined in an aggregate-item definition which is a definition created in advance based on the summary-target-item definition and is what the structured document is stratified; and
a database creating unit that creates a database definition based on the aggregate-item definition to which the new item is added at the adding thereby creating a database, and inputting data to the database by using the structured document to be processed.

7. The financial-analysis support apparatus according to claim 6, wherein the a higher-level item extracting unit extracts a higher-level item including the new item as a low-level item with, as a retrieval key, at least one piece of information out of pieces of information on the higher-level item included in information that the new item has.

8. The financial-analysis support apparatus according to claim 6, further comprising a display output unit that displays the new item and/or the higher-level item if the summary-target-item determining unit determines that the higher-level item of the new item is not an object to be summarized.

9. The financial-analysis support apparatus according to claim 8, wherein the display output unit further displays the aggregate-item definition to which the new item is added by the new item definition adding unit.

10. The financial-analysis support apparatus according to claim 6, wherein
each item includes, as information on the item itself, an item name, a link-base file name for defining the display order of the item among items, and a URI and a namespace identifier indicating location information of the item, and further includes, as information on a higher-level item including the item as a low-level item, a parent item name, a URI and a namespace identifier indicating location information of the higher-level item, and FILENAME indicating a name of a file, and
the higher-level item extracting unit extracts one of higher-level items including the new item as a low-level item by retrieving an item name, a link-base file name, a URI, a namespace identifier, and FILENAME that are included in the higher-level item with, as a retrieval key, at least one piece of information out of a parent item name, a URI, a namespace identifier, and FILENAME that are information on the higher-level item included in information that the new item has.

11. A financial-analysis support method comprising:
determining whether any new item is added to a structured document to be processed by comparing the structured document to be processed with a summary-target-item definition, which is a definition created in advance based on a predetermined structured document and in which items to be summarized are defined in advance;
extracting, if it is determined that a new item is added, a higher-level item including the new item as a low-level item based on the structured document to be processed;
determining whether the higher-level item extracted in the extracting is included in the summary-target-item definition;
adding, if it is determined that the higher-level item of the new item is an object to be summarized, the new item under the higher-level item defined in an aggregate-item definition which is a definition created in advance based on the summary-target-item definition and is what the structured document is stratified; and
creating a database definition based on the aggregate-item definition to which the new item is added at the adding thereby creating a database, and inputting data to the database by using the structured document to be processed.

12. The financial-analysis support method according to claim 11, wherein the extracting includes extracting a higher-level item including the new item as a low-level item with, as a retrieval key, at least one piece of information out of pieces of information on the higher-level item included in information that the new item has.

13. The financial-analysis support method according to claim 11, further comprising displaying the new item and/or the higher-level item on a display output unit if it is determined in the second determining that the higher-level item of the new item is not an object to be summarized.

14. The financial-analysis support method according to claim 13, wherein the displaying further includes displaying the aggregate-item definition to which the new item is added in the adding on the display output unit.

15. The financial-analysis support method according to claim 11, wherein
each item includes, as information on the item itself, an item name, a link-base file name for defining the display order of the item among items, and a URI and a namespace identifier indicating location information of the item, and further includes, as information on a higher-level item including the item as a low-level item, a parent item name, a URI and a namespace identifier indicating location information of the higher-level item, and FILENAME indicating a name of a file, and
the extracting includes extracting one of higher-level items including the new item as a low-level item by retrieving an item name, a link-base file name, a URI, a namespace identifier, and FILENAME that are included in the higher-level item with, as a retrieval key, at least one piece of information out of a parent item name, a URI, a namespace identifier, and FILENAME that are information on the higher-level item included in information that the new item has.
